(19) United States
(12) Patent Application Publication
(10) Pub. No.: US 2008/0158202 A1
(43) Pub. Date: Jul. 3, 2008

(54) Ornament

(76) Inventor: Michael L. Nakamura, Crystal Lake, IL (US)

Correspondence Address: Kevin D. Erickson;Pauley Petersen & Erickson, Suite 365, 2800 West Higgins Road, Hoffman Estates, IL, 60169, US

(21) Appl. No.: 11/648,162

(22) Filed: Dec. 29, 2006

(51) Int. Cl. G09G 5/00

(52) U.S. Cl. 345/204

(57) ABSTRACT

An ornament includes a housing and a hanger at the top of the housing whereby the ornament can be hung on a holiday display, e.g., a Christmas tree. The ornament further includes an electronic memory device for storing images and a data transfer interface for transferring images from an outside data source to the electronic memory device. The ornament also includes a display panel for displaying images thereon and at least one control for selecting images to be displayed on the display panel.

### BACKGROUND OF THE INVENTION

1. Field of the Invention

This invention is directed to an ornament, and more specifically to a holiday ornament that can be suspended on a holiday display, e.g., from a Christmas tree, and includes a display panel for selective display of images thereon, a data transfer interface for uploading images thereto and a user interface for selecting images to be displayed on the display panel.

2. Description of Related Art

Holiday displays, such as for example Christmas trees, are often decorated with photographs. Typically, a photograph is printed, then perforated, and a thread or a string is attached to the photograph to hang the photograph on a holiday display. Paper-type photographs, however, are not best suited for the purpose of displaying on a holiday display. Perforating essentially destroys the photograph and/or makes it aesthetically unpleasing, and often such photograph is tossed away after a single use. The paper on which the photograph is printed tends to deform over time, e.g., curling of edges and/or corners occurs. The additional task of printing the photograph is involved, which often entails making a trip to a local photo store. To display more than one photograph, each photograph must be displayed individually, which can overcrowd the holiday display.

As such, a need arises for an ornament that is sufficiently lightweight to be suspended on a holiday or other decorative display and which can display selected electronic images uploaded directly from an outside data source, such as a computer. There is a need for an ornament that can be reused as new and/or different images are uploaded thereinto.

### SUMMARY OF THE INVENTION

It is an object of this invention to provide an ornament lightweight enough to be suspended on a holiday display, e.g. from a branch of a Christmas tree.

It is another object of this invention to provide an ornament that has a decorative or otherwise desirable shape and/or color.

It is yet another object of this invention to provide an ornament that displays selected electronic images and has the capability to store such images for selective display.

The above and other objects of this invention can be attained with an ornament that includes a housing and a hanger positioned generally on the top of the housing, for attaching the ornament for display. The housing preferably generally defines the shape of the ornament. Preferably, at least a portion of the surface of the housing forms the surface of the ornament, or any part thereof. The housing further includes an aperture and a display panel contained at least partially within the housing, such that at least a portion of the display panel corresponds with the aperture. Images selectively displayed on the display panel are preferably perceivable through the aperture. The display panel displays at least one electronic image thereon and is in operable communication with an electronic memory device which stores electronic images that are selectively displayed on the display panel. Display panel is preferably a digital display panel. The display panel may be recessed within the housing and/or otherwise offset with respect to the surface of the ornament.

The ornament further includes at least one control in operable communication with the display panel and/or the electronic memory device. Controls are preferably used to select images to be displayed on the display panel and/or to activate and/or disactivate the operation of the various electronic components of the ornament of this invention.

The ornament of this invention further includes a data transfer interface, such as a data transfer port, e.g., a USB port, in operative communication with the electronic memory device. Electronic images are uploaded into the electronic memory device from an outside data source, such as for example a computer, through the data transfer port.

The ornament of this invention further includes a power supply in operative communication with the display panel and/or the electronic memory device and/or other electronic components of the ornament. The power supply may be a battery, such as for example a rechargeable battery.

Images displayable on the display panel of this invention may include JPEG, BMP, PNG or GIF images and/or images in other formats. The ornament of this invention is preferably compatible with Windows XP™ and/or Windows 2000™ operating systems, and/or other suitable operating system or systems known to those skilled in the art.

Other objects and advantages of this invention are apparent to those skilled in the art, in view of the following detailed description taken in conjunction with the appended claims and drawings.

### BRIEF DESCRIPTION OF THE DRAWINGS

The present invention can be better understood with reference to the following drawings. In the drawings, like reference numerals designate corresponding parts throughout the several views. The drawings are not necessarily to scale and emphasis is placed upon clearly illustrating principles of the present invention.

FIG. 1 is a perspective view of a holiday ornament according to one embodiment of this invention;

FIG. 2 is a front view of the holiday ornament shown in FIG. 1;

FIG. 3 is a back view of the holiday ornament shown in FIG. 1;

FIG. 4 is a top view of the holiday ornament shown in FIG. 1;

FIG. 5 is a bottom view of the holiday ornament shown in FIG. 1;

FIG. 6 is a side view of the holiday ornament shown in FIG. 1; and

FIG. 7 is a side view of the holiday ornament shown in FIG. 1, showing the side opposite to the side shown in FIG. 6.

### DETAILED DESCRIPTION OF PREFERRED EMBODIMENTS

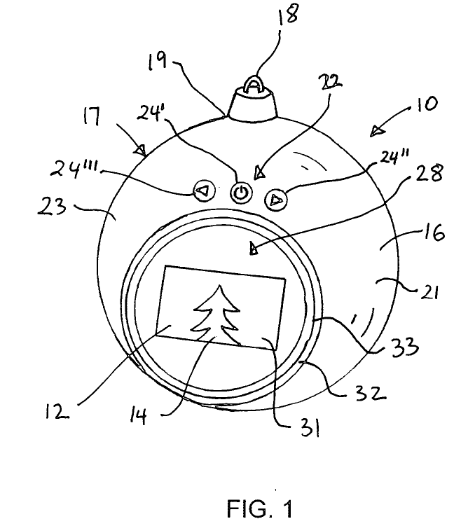

The present invention is directed to an ornament, such as ornament 10 shown in FIGS. 1-7, that can be displayed on a holiday display. As described, ornament 10 is preferably suspended from a holiday display, e.g., a Christmas tree, and includes display panel 12 on which at least one image 14, e.g. a digital photograph and/or a video, is displayable.

Ornament 10 includes housing 16 generally defining shape 17 of ornament 10 and hanger 18 positioned generally on or near top 19 of housing 16 whereby ornament 10 is suspended when in a display mode. Ornament 10 further includes an electronic memory device (not shown) for storing the at least one image 14, data transfer interface 20 for transferring the at least one image 14 from an outside data source to the electronic memory device, and user interface 22, including display panel 12 for displaying the at least one image 14 stored in the electronic memory device and at least one control 24 for selecting images 14 to be displayed on display panel 12. The various electronic components of ornament 10 are preferably powered by a power supply (not shown), such as, for example, a battery. For added power, ornament 10 may be powered by multiple batteries.

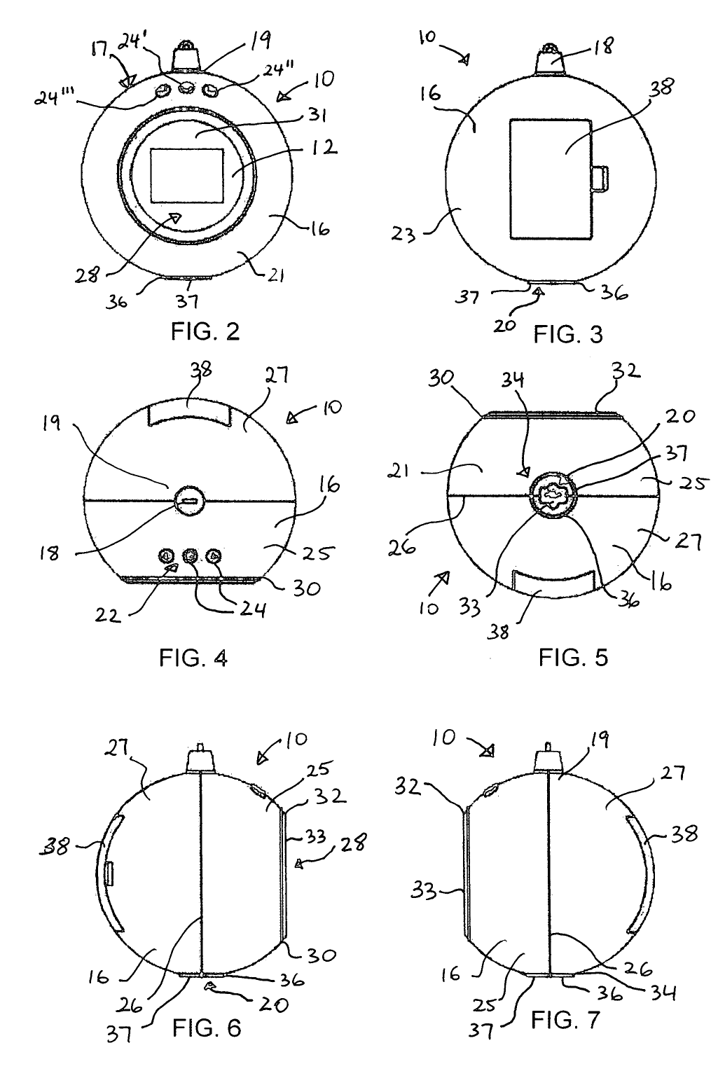

Referring to FIGS. 2 and 3, ornament 10 is shown in a front view and a back view, respectively. Referring to FIGS. 4 and 5, ornament 10 is shown in a top view and a bottom view, respectively. Finally, referring to FIGS. 6 and 7, ornament 10 is shown in two side views, showing the opposite sides of ornament 10.

Housing 16 includes outer surface 21 generally defining shape 17 of ornament 10. Although shape 17 of ornament 10 shown in FIGS. 1-7 is generally spherical, it is apparent to those skilled in the art that housing 16 may be formed in a variety of different shapes and sizes. For example, alternative embodiments of this invention may include housings formed to resemble the shapes of stars, geometrical figures, animals, flowers, or other objects. Housing 16 may have any other decorative and/or desired shape. Furthermore, other elements may be attached to housing 16 for added decoration, or otherwise. Preferably, at least a portion of outer surface 21 of housing 16 forms surface 23 of ornament 10.

Housing 16 may be made of a variety of different materials, including, but not limited to, plastics, metals, or other man-made and/or natural materials, and combinations thereof. Housing 16 may be manufactured as a one piece structure. Alternatively, housing 16 may be assembled from elements manufactured separately. In one preferred embodiment, as shown in FIGS. 4-7, housing 16 is assembled from two structural pieces, front housing element 25 and back housing element 27. Front housing element 25 and back housing element 27 are attached together by any method know to those skilled in the art to form housing 16. Such configuration results in juncture line 26 between front housing element 25 and back housing element 27. Juncture line 26 may be concealed by coating with paint and/or other coloring, or otherwise, substance and/or other element.

Housing 16 preferably at least partially encloses the electronic memory device, the power supply and/or display panel 12 and any associated components. As shown in FIGS. 1-7, in one embodiment of this invention, outer surface 21 of housing 16 is generally spherical and housing 16 includes aperture 28. At least a portion of display panel 12 preferably corresponds with aperture 28. Display panel 12 is nested at least partially within housing 16 in such a way that at least a portion of display panel 12 can be perceived through aperture 28. Periphery 30 of aperture 28 may correspond to the periphery of display panel 12 such that, when in place, surface 31 of display panel 12 is generally flush with surface 21 of housing 16. Alternatively, periphery 30 of aperture 28 may at least partially overlay display panel 12. Display panel 12 is preferably at least partially recessed within housing 16 and/or otherwise offset from surface 21 of housing 16 and/or surface 23 of ornament 10. Offsetting display panel 12 from surface 23 of ornament 10 may prevent or diminish glare on display panel 12 from lights or other objects and thus improve the perceivability of images displayed on display panel 12. Trim element 32 may be placed at least partially along periphery 30 of aperture 28. Trim element 32 preferably forms a ridge at least partially around display panel 12, such that display panel 12 is recessed from edge 33 of trim element 32.

Hanger 18 is preferably placed on or near top 19 of housing 16. Hanger 18 may be formed as an integral part of housing 16. Alternatively, hanger 18 may be formed as a separate component suitably attached to housing 16 by any method known to those skilled in the art. Hanger 18 may be a loop, a hook and/or any other suitable element or combination of elements suitable to attach ornament 10 to a display. Ornament 10 may be suspended on a holiday display by attaching hanger 18 directly to an element of the display. Additionally or alternatively, hanger 18 may be attached to an element of the display by an intermediate element, such as a thread or a string. Hanger 18 may be made of the same or different materials as housing 16.

Ornament 10 includes at least one display panel 12 positioned at least partially within housing 16. At least a portion of surface 31 of display panel 12 may form outer surface 23 of ornament 10. In one embodiment of this invention, display panel 12 is generally flat, as shown in FIGS. 1-7. Alternatively, surface 31 of display panel 12 may have curvature corresponding to the curvature of surface 23 of ornament 10.

Display panel 12 may be any suitable display panel known to those skilled in the art and may employ any suitable digital-image-display technology. In one embodiment of this invention, display panel 12 is a 1.5-inch digital Low Temperature Poly Silicone (LTPS) panel and preferably provides high-resolution color images and/or wide viewing angles. Alternative embodiments of this invention may include any other suitable display panel and/or multiple display panels for viewing the same or different images on each display panel, and each display panel may employ different display technology.

As used throughout this specification, the terms “image” or “images” are intended to refer to any and all electronic images, such as for example still electronic images and/or movies.

Display panel 12 preferably supports a variety of different image formats. In one embodiment of this invention, display panel 12 supports JPEG, BMP, PNG and/or GIF images. In alternative embodiments of this invention, display panel 12 may support other image formats.

Display panel 12 is preferably in operative communication with the electronic memory device, such that images stored in the electronic memory device are displayable on display panel 12 upon selection. In one embodiment of this invention, the electronic memory device is a flash memory device, e.g., 64M flash memory, or any other suitable memory device. The electronic memory device is preferably built-in and enclosed within housing 16. Alternative embodiments of this invention may include a removable electronic memory device, such as, for example, a removable memory card, e.g., a flash memory card.

Ornament 10 further includes one or more controls 24 on surface 21 of housing 16, such as a control panel and/or one or more control buttons, for activating and/or disactivating display panel 12 and/or other electronic components of ornament 10 and/or selecting images 14 to be displayed on display panel 12. Controls 24 are preferably in operative communication with display panel 12 and/or the electronic memory device, such that selected images 14 which are stored in the electronic memory device are displayable on display panel 12.

In one embodiment of this invention, as shown in FIGS. 1, 2 and 4, ornament 10 includes three control buttons 24′, 24″ and 24′″. First control button 24′ may be used as a power or an “on/off” button for turning display panel 12 on and off by pressing button 24′. Second control button 24″ and third control button 24′″ may be used to browse through images 14 stored in the electronic memory device. Specifically, button 24″ is preferably a “forward” button which, when pressed, is used to browse forward through the stored images. Likewise, button 24′″ is preferably a “backward” button which, when pressed, is used to move backward through stored images. Second control button 24″ and/or third control button 24′″ are pressed repeatedly until desired image 14 is selected as displayed on display panel 12. In alternative embodiments of this invention, the selection of images may be remotely controlled, such as for example by the use of a remote control.

Ornament 10 further includes data transfer interface 20, such as data transfer port 33 shown in FIG. 5, on surface 21 of housing 16. Data transfer port 33 is preferably in operative communication with the electronic memory device, such that one or more images 14 are preferably uploaded into the electronic memory device, through data transfer port 33, from an outside data source. In one embodiment of this invention, the outside data source is a computer, and data transfer port 33 is connectable to the computer through a cable connection, e.g., a USB cable, or otherwise, to enable transfer of images stored in the computer into the electronic memory device of ornament 10. Other suitable outside sources of data for uploading images into ornament 10 may include digital cameras, digital video recorders, and/or phone cameras.

In one preferred embodiment of this invention, as shown in FIGS. 5 and 6, data transfer port 33 is positioned on or near bottom 34 of housing 16. Alternative placements of data transfer port 33 on surface 21 of housing 16 are contemplated by this invention.

In one preferred embodiment of this invention, shown in FIG. 5, data transfer port 33 is a Universal Serial Bus (USB) port. A USB cable is connectable to the Universal Serial Bus port on ornament 10 at one end and to an outside data source connection at another end, to facilitate the transfer of selected images. Alternative embodiments of this invention may include other suitable data transfer ports and/or memory card readers, such as CF cards, memory sticks or similar removable storage devices known to those skilled in the art for the transfer and/or storage of electronic data.

Planar surface 36 is preferably formed on surface 21 of housing 16 and at least partially around data transfer port 33, as shown in FIGS. 3 and 5. In one embodiment of this invention, planar surface 36 is about 1 mm high, as measured in the direction away from surface 21 of housing 16. Distal edge 37 of planar surface 36 preferably lies in a plane, such that when ornament 10 is placed on a flat surface, ornament 10 does not tip over, but is supported in an upright position by planar surface 36.

Ornament 10 preferably further includes a power supply (not shown) for supplying power to display panel 12, the electronic memory device and/or other components. In one embodiment of this invention, the power supply is a battery, such as, for example, a 250 mA Li-battery. It is apparent to those skilled in the art that other batteries, or suitable power supplies, known in the art may also be used with this invention. Preferably, but not necessarily, the battery used in connection with this invention is rechargeable. Battery is preferably at least partially enclosed by housing 16 and removable from housing 16 for replacement or recharging through access panel 38 in housing 16.

The ornament of this invention preferably supports Windows XP™ and/or Windows 2000™ operating system and/or other operating system known to those skilled in the art. Software may be provided with the ornament of this invention to facilitate the uploading of images into the electronic memory device.

While in the foregoing specification this invention has been described in relation to certain preferred embodiments thereof, and many details have been set forth for purpose of illustration, it will become apparent to those skilled in the art that the invention is susceptible to additional embodiments and that certain of the details described herein can be varied considerably without departing from the basic principles of the invention. Therefore, to particularly point out and distinctly claim the subject matter regarded as the invention, the following claims conclude the specification.

We claim:

1. A holiday ornament comprising:
a housing generally defining a shape of the ornament;
a hanger positioned on a top of the housing;
a display panel at least partially contained within the housing such that at least a portion of the display panel is visible, the display panel displaying at least one electronic image thereon;
an electronic memory device in operative communication with the display panel, the electronic memory device storing the at least one electronic image for selective display on the display panel;
a data transfer port in operative communication with the electronic memory device, the electronic memory device receiving the at least one image from an outside data source through the data transfer port.

2. The holiday ornament of claim 1 wherein the display panel is a digital display panel.

3. The holiday ornament of claim 2 wherein the digital display panel is a Low Temperature Poly Silicon panel.

4. The holiday ornament of claim 1 wherein the data transfer port is connectable to an outside data source for uploading therethrough the at least one image from the outside data source into the electronic memory device.

5. The holiday ornament of claim 4 wherein the data transfer port is a Universal Serial Bus (USB) port.

6. The holiday ornament of claim 1 further comprising a power supply in operative communication with at least one of the display panel and the electronic memory device.

7. The holiday ornament of claim 6 wherein the power supply is a battery.

8. The holiday ornament of claim 1 wherein the at least one image is at least one of a JPEG, a BMP, a PNG and a GIF image.

9. The holiday ornament of claim 1 wherein the display panel is at least partially recessed within the housing.

10. The holiday ornament of claim 1 wherein the electronic memory device is a flash memory device.

11. The holiday ornament of claim 1 wherein the shape of the ornament is a decorative shape.

12. A holiday ornament for displaying on a holiday display, the ornament comprising:
a generally spherical housing;
a display panel at least partially positioned within the housing, the display panel forming a portion of a surface of the ornament, at least one electronic image displayable on the display panel;
an electronic memory device in operative communication with the display panel, the at least one image storable in the electronic memory device and selectively dispalayable on the display panel;
a data transfer port connectable to an outside data source, the at least one image transferable from the outside data source into the electronic memory device through the data transfer port;
at least one control in operative communication with at lest one of the display panel and the electronic memory device, the at least one control operable to selectively display the at least one image on the display panel; and
a hanger at a top of the housing, the hanger removably attachable to the holiday display.

13. The holiday ornament of claim 12 wherein the display panel is at least partially recessed within the housing.

14. The holiday ornament of claim 12 further comprising a planar surface formed at least partially around the data transfer port.

15. The holiday ornament of claim 12 wherein the housing includes an aperture.

16. The holiday ornament of claim 15 wherein at least a portion of the display panel corresponds to the aperture.

17. The holiday ornament of claim 16 wherein the display panel is recessed from an outer surface of the housing.

18. The holiday ornament of claim 15 further comprising a trim element formed at least partially along a periphery of the aperture.

19. A Christmas tree ornament comprising:
a generally spherical housing, the housing including an aperture having a periphery;
a display panel at least partially positioned within the housing such that at least a portion of the display panel corresponds to the aperture, at least one electronic image displayable on the display panel;
an electronic memory device in operative communication with the display panel, the at least one image storable in the electronic memory device and selectively dispalayable on the display panel;
a data transfer port connectable to an outside data source, the at least one image transferable from the outside data source into the electronic memory device through the data transfer port;
at least one control in operative communication with at lest one of the display panel and the electronic memory device, the at least one control operable to selectively display the at least one image on the display panel; and
a hanger at a top of the housing, the hanger removably attachable to the holiday display.

20. The Christmas tree ornament of claim 19 further comprising a planar surface formed at least partially around the data transfer port.
